(19) United States
(12) Patent Application Publication
(10) Pub. No.: US 2019/0366369 A1
(43) Pub. Date: Dec. 5, 2019

(54) Vertical travel governor for a pump bottle

(71) Applicants: Jake DeLillo, Baltimore, MD (US); Lindsay Lugli, Baltimore, MD (US)

(72) Inventors: Jake DeLillo, Baltimore, MD (US); Lindsay Lugli, Baltimore, MD (US)

(21) Appl. No.: 15/996,502

(22) Filed: Jun. 3, 2018

(51) Int. Cl. B05B 11/00

(52) U.S. Cl. CPC B05B 11/3059

(57) ABSTRACT

The invention is a vertical travel governor for a pump bottle. The governor is provided in a range of thicknesses, corresponding to a range of distances that the nozzle of a pump bottle will be allowed to travel downward vertically, and is comprised of a semi-rigid C-shaped clamp and a handle terminating in a knob. The clamp is easily secured around the shaft of the pump, and stops the downward travel of the nozzle. The knob enables the user to easily remove the governor when the bottle is empty, and transfer the governor to a new bottle.

### CROSS-REFERENCE TO RELATED APPLICATIONS

This application relates back to, and claims the priority of Provisional Patent Application No. 62/524,447 filed on Jun. 23, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to institutional supplies and accessories, and in particular to a vertical travel governor for a pump bottle. Operating in a school setting and or daycare, a nursing home, or other institution, serving a large number of people on a limited budget, can be very challenging and wasting labor and supplies must be avoided due to their cost. Generally, certain types of supplies such as condiments or hair care products are supplied in large pump bottles. The vertical travel of the pump nozzle on the bottle may yield too much of the product, resulting in waste. Accumulation of air bubbles in the pump itself may also result in a splattering mess, which costs labor for cleaning in addition to the wasted supplies. A device which can be attached to the nozzle shaft, which will limit vertical travel of the nozzle and prevent accumulation of air bubbles, would save both supplies and labor, and would be well received.

A search of the prior art reveals various devices which have been developed to provide the features of a camera, which is concealed within an ordinary and inobtrusive household object. None are closely related to the present invention, but several include features which resemble those of the present invention. Each has proven to be less than satisfactory for the present purpose in its own way.

Drive shaft travel limiting device, U.S. Pat. No. 3,308,901 (priority Jun. 25, 1965), provides driveline constructions for motor vehicles, and more particularly to a device for limiting the vertical travel of a vehicles drive shaft. In the conventional passenger car, the rear wheels are rotatably supported at the outer ends of a rigid transversely extending axle housing. A longitudinally extending drive shaft is connected to differential gearing that is situated within the axle housing. This gearing, in turn, feeds driving torque through axle shafts within the housing to the driving wheels. The chassis of the vehicle is supported by the suspension system on the axle housing. The axle housing and drive shaft are free to traverse a vertical jounce and rebound path due to the flexibility of the suspension system. In order to prevent the differential housing from crashing into the underbody of the vehicle upon extreme jounce conditions, a rubber bumper is interposed between the vehicle frame and the axle housing. During acceleration, the axle housing is subjected to a torque reaction that tends to rotate the housing about a transverse axis. This condition is known as axle windup. When the suspension is of the Hotchkiss type having longitudinal leaf springs, the springs will tend to distort into an ogee under such conditions.

Multiple circuit control switch with guide stops for limiting the vertical travel of a springlike movable contact, U.S. Pat. No. 3,529,109 (priority Jun. 12, 1968), provides a multiple circuit control switch manually operable in a pivotal movement to provide circuit closure of electrical connectors is positionally held in central circuit disengaged position by a contacting springlike member forcibly held by a compressed spring against inwardly extending guidestop members of a support and guide member. it is an object of the present invention to provide an improved multiple circuit control switch. Another object of the invention is to enhance the centering of a double throw-center off type of switch. A further object of the invention improves the uniformity of applied pressure required to shift a multiple circuit control switch from a non-operational to an operational position. These and other objects and advantages are achieved in one aspect of the invention by a multiple circuit control switch having a base member to which is affixed spaced electrical connectors, an upstanding post-like member, and a support and guide member. A spring telescopes over the post-like member and a flexible spring-like member telescopes over the post-like member contacting the spring and positionally held by the support and guide member which also pivotally holds a circuit closing member.

Adaptor for palletized loading system, U.S. Pat. No. 5,865,579 (priority Feb. 27, 1997), provides an adaptor for a vehicle load bed having stake pockets along lateral edges. The adaptor allows pallets having indented peripheries to roll over the bed and to be locked in place on the bed. The adaptor has a base lying on the bed and guides in the form of upright walls disposed along lateral edges of the base. The guides keep the pallet on the bed as the pallet rides along the bed. Stakes on the bottom of the base are locked into the pockets to retain the adaptor to the bed. Extending from the walls are lips disposed over the pallet so as to limit or eliminate the pallet's vertical travel. The pallets ride on elongate rollers journalled between roller supports. The supports are fixed on the base parallel to the walls. Apertures of the same shape are defined both in the lips and the base and are aligned with one another. To fix the pallets to the adaptor, locking members are passed through the lip apertures, fit with indents of the pallets and passed through the base apertures.

Semicontinuous vertical lift, U.S. Pat. No. 3,447,670 (priority May 2, 1967), provides a conveyor for transporting articles vertically in either direction having two adjacent tiers of platforms, the tiers being arranged to move in opposite vertical directions simultaneously, producing at one limit of movement, inclined ramps each consisting of two platforms, one belonging to each tier, and at the other limit of movement ramps of the same type but inclined in the opposite direction and consisting of a different pairing of the platforms. The articles are raised or lowered, step by step, as they are transferred back and forth over the inclined ramps. Controls in the form of selectively activated stops and variation in the total vertical movement of the tiers change the conveyors direction of article movement from descending to ascending.

Ball retrieving and storage devices, U.S. Pat. No. 3,926,465 (priority May 29, 1973), provides a ball retrieving and storage device includes a container having an elongated handle extending above it, and one or more movable gate members in the bottom of the container. In one form of the invention, each gate member comprises a vertically movable elongated lifting bar having loops at its opposite ends loosely fitted around opposite sides of the container for allowing the bar to move vertically up and down relative to the bottom of the container. In another form of the invention, the gate members are hinged to a portion of the container bottom and adapted to swing into the container. Balls are retrieved from the ground by placing the bottom of the container over the balls and exerting a downward force on the handle to force the balls up against the bottom of the movable gate member which opens the gate and provides an enlarged opening in the bottom of the container for allowing each ball to pass into the container. Continued downward movement causes the moving gate to engage stop bars on opposite sides of the container for limiting further vertical movement of the gate sufficiently to allow the equator of each ball to pass through the enlarged opening and then allow the gate to automatically drop to a closed position to retain the balls in the container. A cylindrical-shaped cage also is disclosed which provides a rotary type ball retriever adapted to be rolled on the ground to engage balls which automatically open gate members spaced around the outer circumference of the cage.

The purpose of the present invention is to correct the deficiencies in the existing inventions cited herein, and thereby provide a substantial improvement over all the prior art. A vertical travel governor for a pump bottle, enabling a user to limit the vertical travel to any one of a range of distances as desired, would resolve this problem.

### SUMMARY OF THE INVENTION

Accordingly, the invention is a vertical travel governor for a pump bottle. The governor is provided in a range of thicknesses, corresponding to a range of distances that the nozzle of a pump bottle will be allowed to travel downward vertically, and is comprised of a semi-rigid C-shaped clamp and a handle terminating in a knob. The clamp is easily secured around the shaft of the pump, and stops the downward travel of the nozzle. The knob enables the user to easily remove the governor when the bottle is empty, and transfer the governor to a new bottle.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment in the closed position, displaying the governor 10, the clamp 11, the handle 12, and the knob 13.

FIG. 2 is a top view of the first exemplary embodiment in the open position, displaying the governor 10, the clamp 11, the tongue 11A, the handle 12, and the knob 13.

FIG. 3 provides rear perspective views of the small, medium, and large versions of the first exemplary embodiment, displaying the clamps 11, and the knobs 13.

FIG. 4 is a front perspective view of a pump bottle in the recovered position with the first exemplary embodiment affixed, displaying the governor 10, the clamp 11, the handle 12, the knob 13, the pump bottle 14, the nozzle 15, and the shaft 16.

FIG. 5 is a front perspective view of a pump bottle in the depressed position with the first exemplary embodiment affixed, displaying the governor 10, the clamp 11, the handle 12, the knob 13, the pump bottle 14, and the nozzle 15.

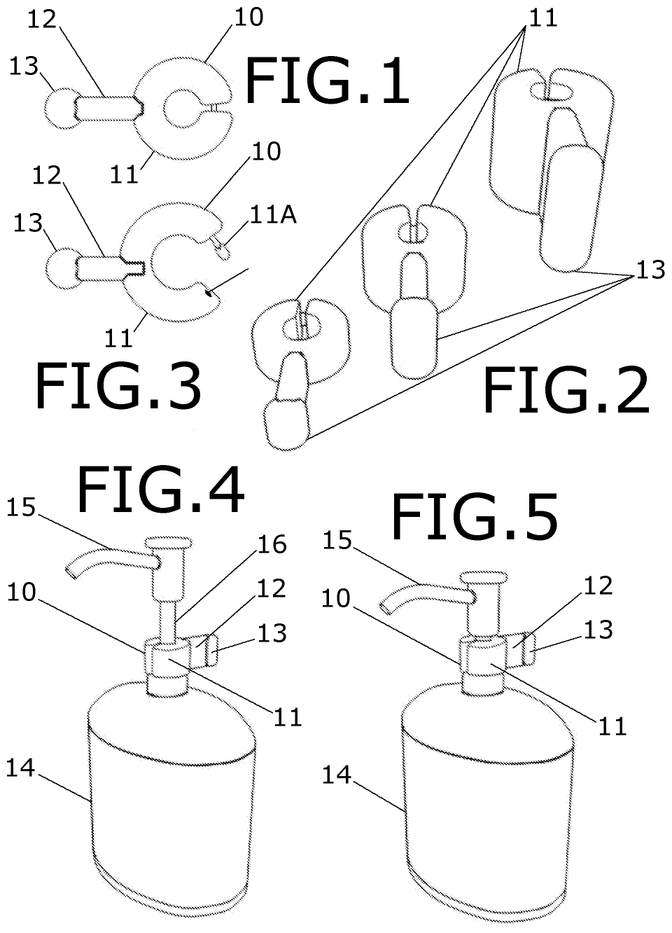

### DETAILED DESCRIPTION OF THE INVENTION

Referring now to the invention in more detail, the invention is a vertical travel governor for a pump bottle.

It is to be understood that while the invention is intended for use with a pump bottle, this is not intended as a limitation. With suitable modifications or with no modifications at all, the invention may be used on any generally cylindrical body, wherein a moving part or protrusion travels downward vertically along the axis of the cylindrical body, and limiting the distance of downward travel is desired.

The first exemplary embodiment provides a governor 10, comprised of a semi rigid C-shaped clamp 11 and a handle 12 terminating in a knob 13, to be used with a pump bottle 14 which is not provided. The end of one jaw of the clamp 11 provides a tongue 11A which may be inserted into a corresponding aperture in the end of the opposing jaw of the clamp 11. This secures the clamp 11 in the closed position. The tongue 11A is secured by friction and flexibility.

Thus the clamp 11 is easily secured around the shaft 16 of the pump bottle 14, and stops the downward travel of the nozzle 15. The knob 13 enables the user to easily remove the governor 10 when the pump bottle 14 is empty, and transfer the governor 10 to a new pump bottle 14.

The first exemplary embodiment is provided in a plurality of versions, and is preferably provided in three versions. The versions provide a range of thicknesses, corresponding to a range of distances that the nozzle 15 of the pump bottle 14 will be allowed to travel downward vertically. The three preferred versions are small, medium, and large.

To use the first exemplary embodiment, the user may place the governor 10 such that the clamp 11 rests against the shaft 16 of the pump bottle 14. The user may then press firmly on the knob 13, which opens the clamp 11 sufficiently to pass and close around the shaft 16. When the pump bottle 14 is empty, the user may grasp the knob 13 firmly with the thumb and forefinger, and pull the governor 10 off the shaft for placement on a new pump bottle 14.

The governor 10 is preferably manufactured from a semi-rigid, durable material which is corrosion resistant, such as plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A vertical travel governor for a pump bottle, comprised of a semi rigid C-shaped clamp and a handle terminating in a knob, to be used with a pump bottle which is not provided.

2. The governor of claim 1, wherein the end of one jaw of the clamp provides a tongue which may be inserted into a corresponding aperture in the end of the opposing jaw of the clamp, securing the clamp 11 in the closed position by friction and flexibility, thus stopping the downward travel of the nozzle.

3. The governor of claim 1, wherein the knob enables the user to easily remove the governor when the pump bottle is empty, and transfer the governor to a new pump bottle.

4. The governor of claim 1, wherein the governor is preferably provided in three versions which provide a range of thicknesses, corresponding to a range of distances that the nozzle of the pump bottle will be allowed to travel downward vertically.

5. The governor of claim 1, wherein the user may place the governor such that the clamp rests against the shaft of the pump bottle. The user may then press firmly on the knob, which opens the clamp sufficiently to pass and close around the shaft.

6. The governor of claim 1, wherein when the pump bottle is empty, the user may grasp the knob firmly with the thumb and forefinger, and pull the governor off the shaft for placement on a new pump bottle.

7. The governor of claim 1, wherein the governor is preferably manufactured from a semi-rigid, durable material which is corrosion resistant, such as plastic.
